(19) United States
(12) Patent Application Publication
(10) Pub. No.: US 2016/0110836 A1
(43) Pub. Date: Apr. 21, 2016

(54) Arranging on-demand services based on one or more predefined rules

(71) Applicant: Uber Technologies, Inc., San Francisco, CA (US)

(72) Inventors: Sunil Kumar Garg, San Francisco, CA (US); Stacey Corwin Farrelly, Oakland, CA (US); Ryan David McKillen, San Francisco, CA (US); Maya Paritosh Choksi, San Francisco, CA (US)

(21) Appl. No.: 14/520,095

(22) Filed: Oct. 21, 2014

(51) Int. Cl. G06Q 50/30; G06Q 20/40

(52) U.S. Cl. CPC G06Q 50/30; G06Q 20/405

(57) ABSTRACT

A transport request for a transport service for a user can be received from a user device. Based, at least in part, on information from the transport request, a computing system can determine that the transport request is subject to one or more rules stored in a rules database accessible by the computing system. In response to determining that the transport request is subject to one or more rules, the computing system can determine whether the transport request is valid based, at least in part, on the one or more rules and information from the transport request. In response to determining that the transport request is valid, the transport request can be processed to select a driver to provide the transport service for the user. In addition, the cost for the transport service can be paid by an entity other than the user.

### BACKGROUND

An on-demand service arrangement system can enable users to request on-demand services through use of computing devices. For example, users can operate service applications on their computing devices to exchange information with the on-demand service arrangement system for purposes of requesting transport services or delivery services. In some instances, a business or entity can set up a business account with the on-demand service arrangement system in order to enable employees and agents of the business to request on-demand services through their association with the business.

### BRIEF DESCRIPTION OF THE DRAWINGS

FIG. 1 illustrates an example system to arrange on-demand services based on one or more predefined rules.

FIGS. 2A and 2B illustrate example methods for arranging and processing on-demand services based on one or more predefined rules.

FIG. 3 illustrates an example rules database for use with the on-demand service arrangement system.

FIG. 4 illustrates another example method for arranging on-demand services based on one or more predefined rules.

FIG. 5 is a block diagram that illustrates a computer system upon which embodiments described herein may be implemented.

FIG. 6 is a block diagram that illustrates a mobile computing device upon which embodiments described herein may be implemented.

### DETAILED DESCRIPTION

Examples described herein provide for an on-demand service arrangement system that accesses stored rule data in order to process requests for on-demand services that are received from user devices. In some examples, the system can determine whether a request for an on-demand service is valid based on one or more rules that are applicable to the request and based on information included in the request. If the system determines that the request is valid, the system can process the request to select a service provider for the user.

According to examples, a plurality of rules can be stored in a rules database or data store that is accessible by the system. A rule can specify or provide one or more preferences, restrictions, and/or requirements that a request must satisfy in order for the system to arrange an on-demand service for a user. Such a rule can be associated with a user account or profile or be associated with an account corresponding to a business, company, entity, or group (referred to herein as a business). For example, an account associated with a business (referred to herein as a business account) can be created and stored by the system to enable the business to pay for on-demand services for users associated with that business account (e.g., the business's employees and agents). The business can associate or configure, with the business account, one or more rules that specify or dictate when on-demand services are to be paid for by the business on behalf of its authorized users. In such examples, the system can enable a business to control the manner in which its employees can request and receive on-demand services.

For example, the system can receive, from a user device, a transport request for a transport service. Based on at least some information included in the transport request, the system can determine whether the user is associated with a business account, and if so, determine whether the transport request is subject to one or more rules that is associated with the business account. Depending on variations, a transport request can include an identifier (ID) associated with the user or the user device, a transport type information, a pickup location, a destination location, and/or a payment profile ID. As described herein, a payment profile ID can correspond to a payment profile stored with the system, and can include financial information (e.g., a bank account, mobile wallet account, credit card number, etc.) and billing information (e.g., name, address, phone number, email address, etc.) for that payment profile. Based on the payment profile ID in a transport request, the system can use the financial information in the corresponding payment profile to charge the user for a transport service (e.g., after detecting the completion of the transport service).

In one example, based, at least in part, on the payment profile ID included in the transport request, the system can determine that the transport request is subject to one or more rules. In response, the system can determine whether the transport request is valid based, at least in part, on the one or more rules and at least one of the transport type information or the pickup location from the transport service. If the transport request is determined to be valid, the system can process the transport request in order to select a driver to provide the transport service for the user. On the other hand, if the transport request is determined to be invalid as a result of failing to comply with the applicable one or more rules, the system can transmit a message to the user device, indicating that the transport request is invalid, informing the user why the transport request in invalid, and/or requesting the user to select a different payment profile or change the transport type and/or the pickup location. The system can cease performing additional computational processes, such as selecting a driver based on driver data, transmitting an invitation to the selected driver, etc., thereby conserving processing resources. In this manner, the system can enforce one or more rules to permit or prevent users from making transport requests.

For example, a business can configure a rule in which its employees are required to request a transport service using a particular vehicle type or class. If an authorized employee of the business makes a transport request for a different vehicle type using a payment profile associated with the business, the system can receive the transport request, determine that the user is associated with business's account, identify the rule, and based on the rule and transport type information, determine that the transport request is invalid. In another example, a business can configure a rule in which the business is to pay for transport services that originate or start in a particular region (e.g., a specified region encompassing the headquarters of the business) and/or that are made during a particular duration of time. The system can store and enforce other rules for validating or invalidating transport requests. In some examples, the system can also enforce one or more rules during the performance of the transport service and/or after completion of the transport service for purpose of determining what portion of the cost for the transport service is to be charged to the user (e.g., none of the cost, some of the cost, all of the cost).

As used herein, a client device, a driver device, a computing device, and/or a mobile device refer to devices corresponding to desktop computers, cellular devices or smartphones, personal digital assistants (PDAs), laptop computers, tablet devices, etc., that can provide network connectivity and processing resources for communicating with the system over one or more networks. Client devices and driver devices can each operate a designated service application (e.g., a client application and a driver application, respectively) that is configured to communicate with an on-demand service arrangement system. A driver device can also correspond to a computing device that is installed in or incorporated with a vehicle, such as part of the vehicle's on-board computing system.

Still further, examples described herein relate to a variety of on-demand services, such as a transport service, a food truck service, a delivery service, an entertainment service, etc. to be arranged between users and service providers. In other examples, the system can be implemented by any entity that provides goods or services for purchase through the use of computing devices and network(s). For purpose of simplicity, in examples described herein, the on-demand service arrangement system can correspond to a transport arrangement system that arranges transport services to be provided for users by drivers of vehicles.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

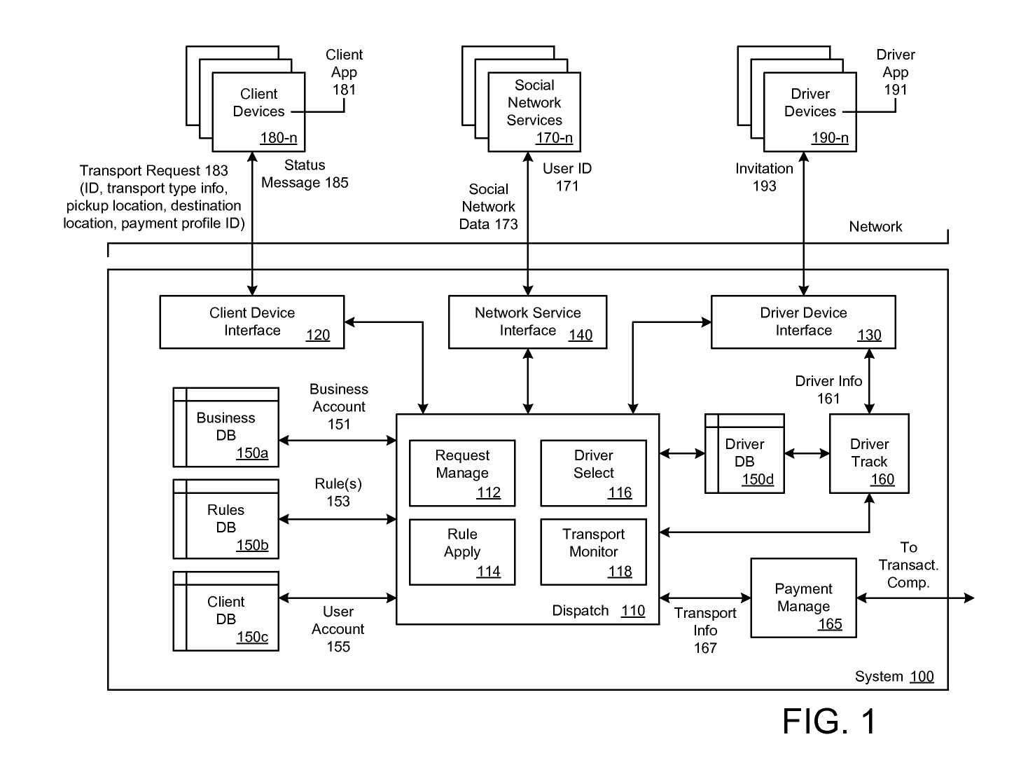

FIG. 1 illustrates an example system to arrange on-demand services based on one or more predefined rules. In FIG. 1, an on-demand service arrangement system 100 (referred to herein as system 100), can include a dispatch 110, a client device interface 120, a driver device interface 130, a network service interface 140, a driver track 160, and a payment manage 165. The system 100 can also include a plurality of databases or data stores, including a business database 150a, a rules database 150b, a client database 150c, and a driver database 150d. A plurality of client devices 180, which are operated by users requesting the on-demand services, and a plurality of service provider devices 190 (referred to herein as driver devices 190 for purpose of simplicity) can communicate with the system 100 over one or more networks using, for example, respective designated service applications 181, 191 that are configured to communicate with the system 100. The components of the system 100 can combine to access stored rule data to process requests for on-demand services that are received from the client devices 180 and/or to arrange the on-demand services to be provided for the requesting users subject to one or more rules. Logic can be implemented with various applications (e.g., software) and/or with hardware of a computer system that implements the system 100.

Depending on implementation, one or more components of the system 100 can be implemented on network side resources, such as on one or more servers or data centers. The system 100 can also be implemented through other computer systems in alternative architectures (e.g., peer-to-peer networks, etc.). As an addition or an alternative, some or all of the components of the system 100 can be implemented on client devices, such as through applications that operate on the client devices 180 and/or the driver devices 190. For example, a client service application 181 (referred to herein as client application 181) and/or a service provider application 191 (referred to herein as driver application 191) can execute to perform one or more of the processes described by the various components of the system 100. The system 100 can communicate over one or more networks, via a network interface (e.g., wirelessly or using a wire), to communicate with the client devices 180 and the driver devices 190.

The system 100 can communicate, over one or more networks, with client devices 180 and driver devices 190 using a client device interface 120 and a device interface 130, respectively. The device interfaces 120, 130 can each manage communications between the system 100 and the respective computing devices 180, 190. The client devices 180 and the driver devices 190 can individually operate client applications 181 and driver applications 191, respectively, that can interface with the device interfaces 120, 130 to communicate with the system 100. According to some examples, these applications can include or use an application programming interface (API), such as an externally facing API, to communicate data with the device interfaces 120, 130. The externally facing API can provide access to the system 100 via secure access channels over the network through any number of methods, such as web-based forms, programmatic access via restful APIs, Simple Object Access Protocol (SOAP), remote procedure call (RPC), scripting access, etc.

The system 100 can provide a platform to enable users and drivers to use their computing devices 180, 190 to request and provide transport services, respectively. For example, each user of the system 100 can have a corresponding user account 155 or profile stored in the client database 150c and each driver of the system 100 can have a driver account or profile stored in the driver database 150d. A user account 155 can include or be associated with a user identifier (ID), user information (e.g., name, contact information, location or address), device information (e.g., device type, application version information), and at least one payment profile. A payment profile can correspond to financial information associated with the user, such as banking account information, mobile wallet account information or credit card information, etc. which the user has configured with the user account 155 for purpose of paying for a transport service. Each payment profile can also include a corresponding payment profile ID and billing address information. In this manner, the system 100 can use information from a payment profile that the user has chosen or designated to pay for a transport service, and automatically charge an account associated with the payment profile.

For example, a user can operate the client application 181 to generate and transmit a transport request 183 to the system 100. The user can interact with a user interface feature provided by the client application 181 to specify a vehicle type, a pickup location, and/or a destination location, and select a feature(s) to cause the client application 181 to generate and transmit the transport request 183. Depending on variations, the transport request 183 can include an ID associated with the user account or the user's client device 180 (e.g., a user name or user ID, a hash of the user name or user ID, an ID corresponding to the client device 180), a transport type information (e.g., information indicating what type of vehicle the user wants to be transported in), a pickup location (e.g., a location data point, such as a latitude and a longitude), a destination location, and/or a payment profile ID. In one example, the pickup location can correspond to a current location of the client device 180 that is determined by a global positioning system (GPS) resource of the client device 180. The client application 181 can receive the current location and include the current location as the pickup location in the transport request 183.

In addition, in some examples, because the user may have more than one payment profile associated with the user account 155, the user can specify, through user input on the client application 181, which payment profile to use to pay for the transport service. In one example, the client application 181 can automatically include, in the transport request 183, a default or user-specified preferred payment profile ID and/or the last, previously used payment profile ID. As an addition or an alternative, the client application 181 can enable the user to change and/or select the payment profile ID before the transport request 183 is confirmed by the user and transmitted to the system 100.

The dispatch 110 can receive the transport request 183 via the client device interface 120. In one example, the request manage 112 can receive the transport request 183 and determine information from the transport request 183, such as the ID, the transport type information, the pickup location, the destination location, and/or the payment profile ID. The request manage 112 can analyze and parse the transport request 183, for example, to identify the various information associated with or make up the transport request 183. Based on at least some of the received information, the request manage 112 can determine whether the user is associated with a group or business account 151.

According to some examples, the system 100 can enable a business, company, entity, or group (referred to herein as a business for purpose of simplicity) to create and manage an account for that business (e.g., a business account 151). Each business account 151 can be stored in a business database 150a and can include or be associated with a business ID, business information, contact information associated with the business, one or more payment profiles, a plurality of authorized employees' IDs (and user information) associated with the business, and/or one or more rules. An administrator or administrative user of a business can set up a business account 151 with the system 100 to pay for transport services received by the business's authorized employees and/or agents (provided that the transport services satisfy conditions specified by the business). For example, the system 100 can provide a portal to enable an administrator of a business account 151 to add or remove authorized employees from the business account 151, edit business information, and/or add, edit, or delete payment profiles for the business account 151.

Referring back to the example, in one variation, the request manage 112 can identify the payment profile ID from the transport request 183 and determine if the payment profile ID matches a stored payment profile ID associated with a business account 151. For example, the request manage 112 can perform a search operation of the business database 150a using the payment profile ID from the transport request 183. If the request manage 112 determines that the payment profile ID does not match a payment profile ID associated with a business account 151 and/or if the request manage 112 determines that the payment profile ID matches one associated with the user's account 155, the request manage 112 can cause the dispatch 110 to process the transport request 183 normally, e.g., the driver select 116 can select a driver for the user based on the pickup location, the destination location, and/or driver information from the driver database 150d (e.g., such as the drivers' current locations and statuses). For example, the driver track 160 can periodically and/or intermittently receive driver information 161 from driver devices 190, via the driver device interface 130, including the location of the driver devices and/or the state of the driver (e.g., active, available to provide transport services, unavailable, off-duty, etc.), and update the driver database 150d with real-time or close to real-time information about drivers. The location of a driver device can be determined by the GPS resource of the driver device, which the driver application 191 can retrieve and transmit to the system 100.

Alternatively, if the request manage 112 determines that the payment profile ID matches a stored payment profile ID associated with a business account 151, the request manage 112 can identify the corresponding business ID of the business account 151. In some examples, the request manage 112 can also compare the ID associated with the user and/or the client device 180 with the list of authorized employee IDs to verify that the user is an authorized employee who can use the payment profile of that business account 151. The rule apply 114 can access or retrieve the business account 151 to determine whether the business account 151 has specified any rules for its employees (e.g., whether the user's transport request 183 is subject to any rules).

In one example, if transport request 183 is not subject to any rules (e.g., the business account 151 does not have any associated rules), the rule apply 114 automatically determines that the transport request 183 is valid and the dispatch 110 can process the transport request 183 normally. On the other hand, if the business account 151 has specified or is associated with one or more rules (e.g., identified by rule IDs), the rule apply 114 can search the rules database 150b to determine the corresponding rule data 153. The rule apply 114 can check the parameters of the transport request 183 (using information from the transport request 183) as compared to the rule(s) data 153 to determine whether the transport request 183 is valid. For example, based on (i) the rule data 153, (ii) the time the transport request 183 was made by the client device 180 and/or received by the system 100, (iii) the transport type information, (iv) the pickup location, and/or (v) the destination location, the rule apply 114 can determine if the transport request 183 has satisfied the conditions specified by the business in order for the user to request a transport service using the payment profile of the business account 151.

If the condition(s) of the one or more rules is satisfied, the rule apply 114 can determine that the transport request 183 is valid and cause the driver select 116 to process the transport request 183 in order to select a driver to provide the transport request for the user. In other words, the system 100 can determine that the conditions of the user's transport service request is such that the user's employer (e.g., the business) has allowed the transport service to be paid on behalf of the user. The dispatch 110 can provide information, e.g., as a status message 185, to the client device 180 informing the user that a driver is being selected and/or indicating that a driver has been selected.

On the other hand, if the condition(s) of the one or more rules is not satisfied, the rule apply 114 can determine that the transport request 183 is invalid. In such case, the dispatch 110 can transmit information, e.g., as a status message 185, to the client device 180 indicating that the transport request 183 has not been processed, indicating that the transport request 183 is not valid because it has not satisfied rule(s) specified by the user's employer, and/or requesting the user to select a different payment profile or change one or more parameters of the transport request 183 to satisfy the rule(s) (e.g., change the transport type, change the pickup location, change the destination location, and/or request at a different time, etc.). The user can then operate the client application 181 to make any preferred changes to the parameters of the transport service and can cause the client application 181 to again transmit a transport request 183 to the system 100. In this manner, if the dispatch 110 determines that the transport request 183 is invalid, the dispatch 110 can stop or suspend the processing of the transport request 183, thereby reducing the amount of computational resources that would otherwise be used by the system 100 (e.g., processing resources used to search and select a driver).

As an addition or an alternative, when the user launches or opens the client application 181 on the user's client device 180, the client application 181 can automatically determine the last or previously used/specified payment profile ID. For example, in response to the client application 181 being launched, the client application 181 and the system 100 can exchange information, including the client application 181 transmitting the current location of the client device 180 and the system 100 providing the previously used payment profile ID to the client application 181. In some examples, the system 100 can determine one or more rules associated with that payment profile ID before the user makes any transport request 183 to the system 100. The system 100 can determine, based on the one or more rules, whether the one or more rules restricts a transport type that can be requested by users associated with that payment profile ID. If a rule(s) restricts the use of the transport service for one or more particular transport types, for example, the system 100 can provide the information about those transport type to cause the client application 181 to display only those transport type as an option(s) for the user. In this manner, the user can be automatically prevented from even being able to select a transport type that is not allowed with the payment profile ID despite additional transport types being available in the given geographic region. The user may select a profile feature to view the user's profile and change the payment profile ID if the user wants to select a different transport type.

### Illustrative Use Case Examples

For illustrative purposes, a number of use case examples in connection with different rules to validate a transport request are described below. The rules can be stored in the rules database 150b of FIG. 1, for example, and can be associated with one or more business accounts 151 stored in the business database 150a. In addition, for purpose of simplicity, the use case examples herein are also described with respect to the request manage 112 of FIG. 1 having already received a transport request from a requesting user's client device 180 and having determined that the requesting user or the client device 180 is associated with a business account and/or is an authorized user of that business account. If the rule apply 114 determines that the condition(s) for a rule is satisfied, the dispatch 110 can process the transport request in order to select a driver for the requesting user. In this manner, the system 100 enables businesses to set and enforce rules for transport services that they are willing to pay for.

In one example, a business can configure a rule (e.g., Rule1) in which the business will pay for a transport service for an authorized user provided that the user selects/uses the cheapest transport type when making a transport request. The system 100 can provide different vehicle types in different geographic regions (e.g., cities, counties, states, countries, etc.) that are available for users to select from when making requests for transport services. The different vehicle types can have different costs associated with them, such as the cheapest vehicle type (e.g., the low-end vehicle type), the most expensive vehicle type (e.g., the luxury or high-end vehicle type), or a set of medium expensive vehicle types (e.g., three vehicle types having a range of prices that are higher than the low-end but less than the high-end). Rule1 can specify that the transport request is to include a transport type information corresponding to the cheapest vehicle type that is available in that geographic region. In this example, the dispatch 110 can determine a given geographic region in which the pickup location is located, determine which transport types are available in that given geographic region, and determine whether the transport type information from the transport request corresponds to the cheapest transport type in that given geographic region. If the transport type condition is satisfied by the transport request, the dispatch 110 can determine that the transport request is valid.

In another example, Rule2 can specify that, in order for a business to pay for a transport service, an authorized user of the business is required to select/use the cheapest transport type when making a transport request, provided that a vehicle corresponding to the transport type is available at the time the user is making the transport request. Rule2 can also specify that if a vehicle corresponding to the cheapest transport type is unavailable, the user is to select/use the next cheapest transport type, and so on. The dispatch 110 can determine a given geographic region in which the pickup location is located, determine which transport types are available in that given geographic region, and determine if drivers that are operating vehicles corresponding to the cheapest transport type is on-duty or active and is available (e.g., is capable of picking up the user). If no such drivers are available, the dispatch 110 can determine whether the transport type information from the transport request corresponds to the next cheapest transport type in that given geographic region. If drivers that are operating vehicles corresponding to the cheapest transport type is available, the dispatch 110 can determine whether the transport type information from the transport request corresponds to the cheapest transport type in that given geographic region. If such a condition(s) is satisfied by the transport request, the dispatch 110 can determine that the transport request is valid.

In a similar example, Rule3 can specify that, in order for a business to pay for a transport service, an authorized user of the business is required to select/use the cheapest transport type when making a transport request, provided that the estimated time of arrival (ETA) of the cheapest transport type is less than a predetermined ETA (or alternatively, is less than or equal to a predetermined ETA). In other words, users can select/use another transport type if the ETA for the cheapest transport type is too long. The dispatch 110 can include an ETA determine component and/or a routing engine (not shown in FIG. 1) that can access a map database (not shown in FIG. 1) to determine an ETA for each available driver in a given area of the requesting user's pickup location based on the current position of the available drivers and the pickup location. For each set of drivers that operate vehicles corresponding to a particular transport type, the ETA determine can determine the individual ETAs of the individual drivers in that set and can determine the ETA of the that transport type by selecting the lowest ETA, the highest ETA, or the average ETA.

In this manner, the dispatch 110 can determine a given geographic region in which the pickup location is located, determine which transport types are available in that given geographic region, and determine whether the transport type information from the transport request corresponds to the cheapest transport type in that given geographic region. If the transport type information does not correspond to the cheapest transport type, the dispatch 110 can determine whether the ETA for that cheapest transport type is greater than (or alternatively, is greater than or equal to) a predetermined ETA. If the ETA is greater than the predetermined ETA, for example, the dispatch 110 can determine that the transport request is still valid even though the cheapest transport type was not selected.

In another example, Rule4 can specify that, in order for a business to pay for a transport service, an authorized user of the business is required to designate a pickup location that is located at or corresponds to a specific location or geographic region, such as at the business's office, within a vicinity of any of the business's offices, or specified hotels, venues, landmarks, etc. Such a rule can be individually configured by a business so that the business can specify particular geographic region constraints that the transport requests must satisfy. For example, a business can associate Rule4 with the business's account and designate, along with Rule4, one or more pickup locations or regions that an authorized user is to set as the pickup location in order for the business to pay the cost of the transport service. An administrator of the business can input, via a portal, multiple addresses, landmarks, latitude and longitude coordinates, etc., to configure as pickup locations. Alternatively, the administrator can create and/or select one or more geofences that each specifies a geographic region as a pickup location. A geofence can be defined by three or more points that make up the perimeter of the geofence.

When applying Rule4, the dispatch 110 can determine the pickup location from the transport request (e.g., a latitude and a longitude coordinate of the pickup location or an address corresponding to the pickup location, etc.) and determine whether the pickup location is at or within a predefined distance of one of the specified pickup location(s), or is within one of the specified pickup geofence(s). The predefined distance (e.g., five hundred feet, one block, one mile, etc.) can configured by an administrator of the system 100 or the business. If the pickup location from the transport request satisfies the pickup location condition, the dispatch 110 can determine that the transport request is valid.

Still further, in another example, Rule5 is similar to Rule4, but can specify that, in order for the business to pay for a transport service, an authorized user of the business is required to designate a destination location that is located at or corresponds to a specific location or geographic region. As discussed, a business can designate, along with Rule5, one or more destination locations or regions that an authorized user is to set as the destination location in order for the business to pay the cost of the transport service. The dispatch 110 can determine the destination location from the transport request (or subsequently received after receiving the transport request but before processing the transport request) and can determine whether the destination location is at or within a predefined distance of one of the specified destination location(s), or is within one of the specified destination geofence(s). According to other examples, another rule can specify that an authorized user is to designate both a business-specified pickup location and a business-specified destination location in order for the business to pay for the user's transport service. The dispatch 110 can determine both the pickup location from the transport request and the destination location from the transport request (or subsequently received after receiving the transport request) and determine whether the pickup location is at or within a predefined distance of one of the specified pickup location(s) and whether the destination location is at or within a predefined distance of one of the specified destination location(s).

Other rules can specify a timing condition(s) that a transport request must satisfy in order for the system 100 to process the transport request. For example, a business can associate Rule6 with the business's account and specify one or more durations of time in which a transport request is to be received. Rule6 can specify that the business will pay for a transport service if an authorized user makes the transport request during a specified duration of time. For example, if the transport request was received by the system 100 during a specified duration of time, the dispatch 110 can determine that the transport request is valid.

In addition, according to some examples, the system 100 can provide a transport type in which individual users of the system 100 can share at least a portion or duration of the transport service (e.g., referred to herein as a carpool transport type). For example, a user can specify a carpool transport type and provide both a pickup location and a destination location when making a transport request. When a first user makes a carpool transport type transport request, the dispatch 110 can search the driver database 150d for a set of drivers that are currently providing transport service to (or currently traveling to pick up) other users who have also specified the carpool transport type (e.g., such a driver can be referred to herein as an engaged driver) and that satisfy predefined conditions based on the first user's pickup and destination locations.

The predefined conditions, for example, can restrict the searching of an engaged driver to one that is (i) traveling in a direction that is similar to the direction the first user would be transported, (ii) transporting another user that may be picked up at a location that is within a predetermined distance of the first user's pickup location or the destination location, or dropped off at a location that is within a predetermined distance of the first user's pickup location or the destination location, or (iii) transporting another user that may be dropped off somewhere along a route between the first user's pickup and destination locations. Still further, the predefined conditions can restrict the searching of an engaged driver to one that is traveling to pick up another user that has a similar pickup location and a similar destination location as the first user's pickup and destination locations, respectively. In other words, each engaged driver of the set should be capable of providing transport service to both the first user and the other user that the engaged driver is assigned to without significantly inconveniencing the users. The dispatch 110 can select, from the set of engaged drivers, an engaged driver that is the best match for the first user (e.g., shortest distance or estimated time of arrival to the first user and/or the shortest distance or estimated time of travel the first user and/or the other user has to travel, individually or in combination). If no such drivers are available, the dispatch 110 can select an available driver that is not providing transport to another user to provide the transport service for the first user.

With reference to such examples, in another example, Rule7 can specify that, in order for a business to pay for a transport service, an authorized user of the business is required to select/use the carpool transport type when making a transport request. Rule7 can also specify that the dispatch 110 is to only select an engaged driver that is currently providing transport service to another authorized user of the business who also specified the carpool transport type, and if no such driver is available, to select an available driver (e.g., one that is not currently providing transport to another user).

In applying Rule7, the dispatch 110 can first determine whether the transport type information from the transport request corresponds to the carpool transport type. If the transport type information corresponds to another transport type, the rule apply 114 can indicate that the transport request is invalid. On the other hand, if the transport type information corresponds to the carpool transport type, the dispatch 110 can search the driver database 150d for a set of engaged drivers that are capable of providing transport service for the requesting user (e.g., engaged drivers that satisfy predefined conditions). The dispatch 110 can determine the user IDs of those users being transported by the set of engaged drivers, and access the business's account to determine if any of those user IDs corresponds to user IDs of authorized users of the business. If no engaged drivers are assigned to an authorized user, the dispatch 110 can select an available driver to provide the transport service for the requesting user. If one or more engaged drivers are assigned to an authorized user, the dispatch 110 can select one of those engaged drivers to also provide the transport service for the requesting user, so that the requesting user can share the transport service with another authorized user of the same business. In this manner, a business can use Rule7 to cause the system 100 to only consider carpool transport type matches for employees of the same business.

Still further, as an addition or an alternative, a business can create a voucher and assign one or more authorized users to use the voucher provided that one or more rules associated with the voucher are satisfied by a transport request. For example, a business can create a one-time voucher for an individual(s) who is coming to an office of the business for a job interview or for a business-related meeting (e.g., a salesperson, a client, etc.). The business can assign an identifier (e.g., an email address) of the individual to a one-time voucher that is assigned to the business account so that the dispatch 110 can search the business account for the individual when a transport request is made. The voucher can specify that the business will pay for the transport service if the transport request is made to or from a geographic region corresponding to the office of the business.

While examples described herein are described with individual rules for a business account, in other examples, a business can specify multiple rules that a transport request must satisfy in order for the requesting user to receive the cost benefit from the business. In such cases, multiple rules that can be applied concurrently. In addition, while examples described refer to rules used by a business, entity, company, or group, other rules can be specified by users for personal use.

For example, a user can specify in the user's own user account 155, one or more rules that can constrain the manner in which transport services can be requested and arranged for the user, such as any of the example rules described above. The user can configure one or more rules with a particular payment profile ID of the user (e.g., if the user has more than one payment profile ID associated with the user account 155), and when requesting the transport service, the user can select that particular payment profile ID in order for the user's transport request to be subject to the one or more rules. In one example, the user can specify a rule that indicates that he or she wants to only make a transport request for a particular transport type(s). In another example, the user can specify a rule (e.g., Rule8) that indicates that he or she wants to be matched with other users that the user knows or is acquainted with (e.g., referred to herein as friends) when the user makes a carpool transport request. The user can specify, with the rule, any of one or more social networks the user is a member of and enable the system 100 to access the user's contacts or friends information from any of one or more social networks (e.g., by providing the user's ID(s) and/or password(s) with the social network(s) to the system 100).

According to an example, the system 100 can communicate, over one or more networks, with one or more social network services 170 using one or more network service interfaces 140. As described herein, a social network service 170 can correspond to a platform provided by a third-party entity that enables users of the social network service 170 to create associations with other users of the social network service 170 (e.g., add users to the user's social network as a friend, acquaintance, business colleague, etc.). Users can individually create a profile or an account with a social network service 170 and can connect to other users to share content and/or communicate with those users using the profile or account. Accordingly, a social network service 170 can include a database(s) that maintains the association between an individual user and other users of the social network service 170. The network service interface 140 can enable the system 100 to make calls to and/or retrieve data from a social network service 170.

Referring back to the example, in applying Rule8, the dispatch 110 can receive the transport request from the client device 180 and identify the payment profile ID. If the payment profile ID is associated with a user (as opposed to a business), the dispatch 110 can determine if the user's account is associated with any rules. In this example, the user has specified Rule8 in the user account. The dispatch 110 can then determine if the transport type information in the requesting user's transport request corresponds to the carpool vehicle type. If it does, the dispatch 110 can communicate with one or more of the user-specified social network services 170 over one or more network service interfaces 140. For example, when communicating with a particular social network 170, the dispatch 110 can transmit the requesting user's user ID 171 with that social network service 170 (e.g., using an API) and receive social network data 173 corresponding to the requesting user. The social network data 173 can include information about the user's friends that the user has connected with and the associated contact information (e.g., phone numbers or email addresses) for those friends.

As an addition or an alternative, the dispatch 110 can also receive contact information of contacts from the user's address book or phone/contacts application on the user's client device 180. In one example, the client application 181 can interface with the phone/contacts application to retrieve the contact information of those contacts associated with the user. The dispatch 110 can store the contact information in a database and associate the contact information with the user's user account 155, or can receive the contact information before, after, or when the user makes the transport request 183.

The dispatch 110 can search the client database 150c using the name, phone number, and/or email address of the requesting user's friends (or in alternative examples, using hashes of the name, phone number, and/or email address) to determine whether any engaged driver that is capable of providing transport service for the requesting user (e.g., engaged drivers that satisfy predefined conditions) is also providing a carpool transport service to any of the requesting user's friends. The dispatch 110 can select such an engaged driver, if any, to provide the transport service for the requesting user. If no such user is found, the dispatch 110 can select an available driver to provide the transport service for the requesting user. In this manner, by specifying such a rule, a user can restrict their transport services to be shared only with friends.

Referring back to FIG. 1, if a transport request 183 is valid, the dispatch 110 can process the transport request 183 for user, including selecting a driver to perform the transport service for the user. For example, the driver select 116 can access the driver database 150d and determine a set of drivers that are available to provide the transport service for the user based on the transport type information, the pickup location, the destination location, and/or driver information from the driver database 150d. The driver select 116 can then select a driver from the set that is closest to the pickup location of the user by distance or ETA, and transmit an invitation 193 to the selected driver's driver device 190. When the driver accepts the invitation 193 via the driver application 191, the transport monitor 118 can determine that the transport service has been arranged for the user.

Once the transport service is arranged for the user, the transport monitor 118 can monitor the transport service by communicating with a driver device 190 of the selected driver through use of the driver service application 191 and/or by communicating with the client device 180 of the user. The driver service application 191 can periodically receive location information determined from the GPS component of the driver device 190 and provide the location information to the system 100. During the progress of the transport service, the dispatch 110 can store information about the transport service as an entry in a transport service database, not shown in FIG. 1, such as the ID of the user who received the transport service, the client device ID, the driver ID, the driver device ID, the route taken, the location data point of the pickup location generated by the GPS component of the driver device 190 (e.g., when the driver indicated that the user has been picked up), the location data point of the drop off location generated by the GPS component of the driver device 190 (e.g., when the driver indicated that the user has been dropped off), the time for pickup and the time for drop off, and/or the price for the transport service, or other transport service information. The transport monitor 118 can determine, based on data provided from the driver device 190 and/or the client device 180, if the transport service has been completed. For example, the driver can provide input on the driver application 191 indicating that the transport service has completed, which causes the driver application 191 to transmit a message to the transport monitor 118 to notify the system 100 accordingly. The transport monitor 118 can determine the location of the driver device 190 at the time the message is received (e.g., by receiving a location data point from the driver application 191).

According to some examples, when the dispatch 110 determines that the transport service has been completed, the rule apply 114 can determine if any rules are applicable to the transport service. Such a post-transport service rule can specify how the payment for the completed transport service is to be determined. For example, a post-transport service rule can specify that the business will always pay a certain flat amount (e.g., twenty dollars) or a percentage (e.g., 75%) of any transport services or a flat amount or portion of any transport services taken in a particular geographic region (e.g., picked up and/or dropped off in a city, a county, a state, etc.). In another example, the dispatch 110 can also confirm, after the transport service has been completed, whether the pickup location of a transport service actually occurred in a geographic region of a specified rule (e.g., based on location data received from a driver device and determined from the GPS component of the driver device at the time the driver indicated that pickup occurred on the driver service application). For example, the user may have specified a certain pickup location in the transport request and may have satisfied a pickup location condition of a rule, but the actual pickup location may have been at a different location. By checking the rule(s) after completion of the transport service, the dispatch 110 can confirm whether the rule(s) is satisfied and whether the business is to pay for the transport service or not.

Still further, in another example, a business can specify a post-transport service rule that indicates that the business will pay for transport services that end at a predefined geographic location or region (e.g., at a hotel, an airport, etc.). The rule apply 114 can determine the location where the drop-off occurred (e.g., where the transport service was completed based on the location data provided by the GPS component of the driver device), and determine if the location is at the predefined location (or within a predetermined distance from the predefined location) or within a predefined region. If the drop-off location satisfies this condition, the rule apply 114 can indicate that the transport service has complied with the rule, and the dispatch 110 can provide transport service information 167 to the payment manage 165 for processing the cost for the transport service. The transport service information 167 can indicate how the transport service is to be paid for. In this example, the trip information 167 can indicate to the payment manage 165 that the transport service is to be paid using the payment profile associated with the previously specified payment profile ID (e.g., one that is associated with the business) because the condition for the rule was satisfied. The payment manage 165 can communicate with a transaction component (not shown in FIG. 1) so that the payment for the transport service can be made appropriately to and from the respective accounts.

On the other hand, if the drop-off location does not match the predefined location or region, the rule apply 114 can determine how the payment for the transport service is to be allocated (e.g., how much the user is to pay, how much the business is to pay). For example, the business can specify that when the drop-off location does not match a predefined location or region, the business will not pay for the transport service, or pay a portion of the transport service (e.g., 25%). In another example, the business can specify that if the pickup location satisfies a rule (e.g., such as Rule4) when the transport request was made, but the drop-off location does not match a predefined location or region, the business will pay for a portion of the transport service (e.g., 50%). In such case, the dispatch 110 can provide transport service information 167 indicating that 50% of the cost is to be paid using the payment profile associated with the previously specified payment profile ID associated with the business and that 50% of the cost is to be paid using a payment profile associated with the user.

### Methodology

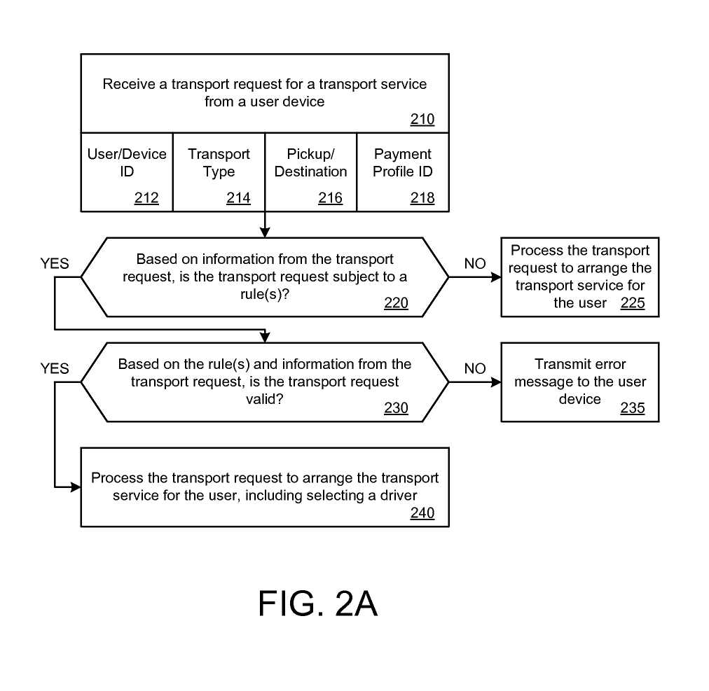

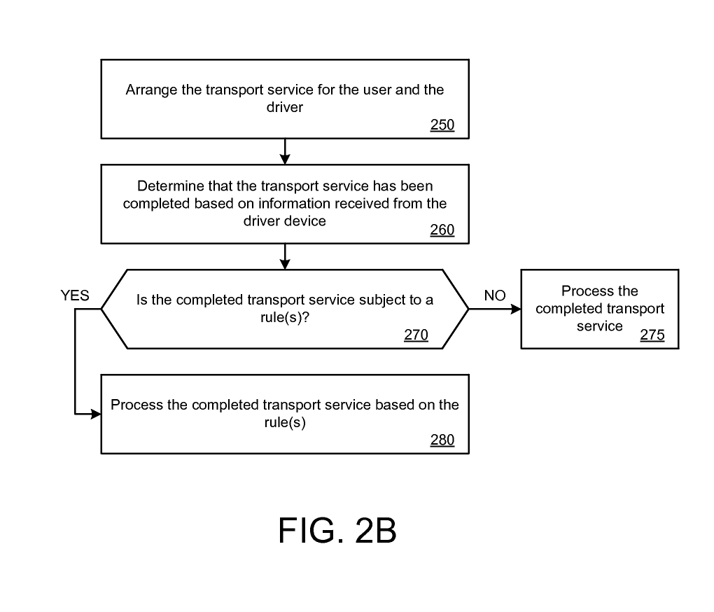

FIGS. 2A and 2B illustrate example methods for arranging and processing on-demand services based on one or more predefined rules. Methods such as described by examples of FIGS. 2A and 2B can be implemented using, for example, components described with an embodiment of FIG. 1. Accordingly, references made to elements of FIG. 1 are for purposes of illustrating a suitable element or component for performing a step or sub-step being described.

Referring to FIG. 2A, the system 100 can receive a transport request for a transport service from a user's client device (210). The user can operate a client application on the client device to communicate with the system 100 over one or more networks and provide input to make the transport request. Depending on implementation, the transport request can include an ID associated with the user and/or the client device, such as a user ID, a device ID, a hash of the user ID or the device ID, etc. (212), a transport type information (214), a pickup location data point and/or a destination location data point (216), and/or a payment profile ID (218). Based, at least in part on, information from the transport request, the system 100 can determine whether the transport request is subject to one or more rules (220).

According to an example, the system 100 can determine, based on the payment profile ID from the received transport request, whether the user is associated with a particular business that has a business account with the system 100. In one example, the system 100 can also verify that the user is an authorized user of that business by first identifying the business account, and then searching the plurality of authorized user IDs or device IDs in the business account for the user ID retrieved from the transport request. If the user ID is found in the plurality of authorized user IDs, the system 100 can determine that the user is associated with a particular business. The system 100 can then determine whether the business account has one or more associated rules that transport requests are subject to.

In another example, the system 100 can determine whether the transport request is subject to one or more rules that is specified by the user, without independent of a group or entity. In such an example, the system 100 can determine if the transport request should be subject to a user-configured rule, such as a carpool transport type rule that constrains how the system 100 is to arrange a carpool transport service for the user (e.g., based on the user ID and the transport type information). The user can specify, in the user's account, one or more rules that the user wants the system 100 to check the transport request against or perform processing of the transport request against when the user makes a transport request.

If the transport request is not subject to any rules, the system 100 can process the transport service normally in order to arrange the transport service for the user. The system 100 can perform a driver selection process to select a driver for the user (225). On the other hand, if the transport request is subject to one or more rules, the system 100 can determine if the transport request is valid based on the one or more rules and based, at least in part, on information from the transport request (230). For example, a rule can specify a particular location condition(s), a timing condition(s), and/or a transport type condition(s), etc. If the transport request is invalid for failing to comply with one or more conditions of one or more rules, the system 100 can cease or suspend processing the transport request and instead, transmit an error message to the client device (235). However, if the system 100 determines that the transport request complies with condition(s) specified in the one or more rules that the transport request is subject to, the system 100 can process the transport request to arrange the transport service for the user, including performing a selection process to select a driver for the user (240).

FIG. 2B is an example method for processing on-demand services based on one or more predefined rules. In one example, the steps of FIG. 2B can be performed by the system 100 after completing the driver selection process for the user (e.g., after steps 225 or 240 of FIG. 2A). For example, the system 100 can arrange a transport service for the user by selecting a driver to perform the transport service for the user (250). Once the transport service is arranged for the user, the system 100 can receive (e.g., periodically and/or intermittently) location data from the driver device (e.g., as well as the client device) while the driver travels to the pickup location of the user and travels from the pickup location to the destination location. The system 100 can also receive information, such as status information, from the driver device and/or the client device. The status information can indicate the state of the driver and/or when the user has been picked up and when the user has been dropped off (e.g., via input provided by the driver and/or the user, respectively). Using this information, the system 100 can monitor the transport service, and record time and location information corresponding to the transport service.

Based on information received from the driver device and/or the client device, the system can determine when the transport service has been completed (260). When the transport service is determined to be completed, the system 100 can determine if the transport service is subject to one or more rules (270). For example, the system 100 can access the business account or the user's account based on the payment profile specified in the transport service, and then determine whether the business account or the user's account has one or more rules associated with the account (e.g., such as described with respect to FIG. 2A). The one or more rules can specify the manner in which the system 100 is to charge the business's financial account(s) and/or the user account(s) for the transport service based on the characteristics of the transport service (e.g., the pickup location, the time the user was picked up, the route taken, the distance traveled, the duration of the transport service, the destination location, etc.). If the completed transport service is not subject to any rules, the system 100 can process the transport service normally, e.g., charge the entirety of the cost for the transport service to the financial account associated with the specified payment profile ID in the transport request (275).

On the other hand, if the transport service is subject to one or more rules, the system 100 can process the transport service based on the rule(s) and the characteristics of the transport service (280). For example, a rule can specify that the business will pay for all (or a portion) of the cost for the transport service provided that the characteristic(s) of the transport service satisfies a condition(s) of the rule. In one example, a rule can specify that the business will pay for all (or a portion) of the cost for the transport service if the drop off location of the transport service is within a particular geographic region, or is at or within a predefined distance from a specified destination location. The system 100 can determine, from the information received from the driver device, the drop off location of the transport service, and compare the drop off location with the particular geographic region or the specified destination location. Based on the determination, the system 100 can charge the appropriate financial account of the business and/or the user accordingly.

In another example, a rule can specify that the business will pay for only a flat dollar amount or a certain percentage of the cost if the transport service is provided during a certain time period, if the total distance traveled for the transport service, and/or if the duration of the transport service is less than a certain amount of time. Accordingly, an administrator of the business can customize and specify different conditions for different rules to control what transport requests can be made by their employees as well as to control when the business will pay for completed transport services.

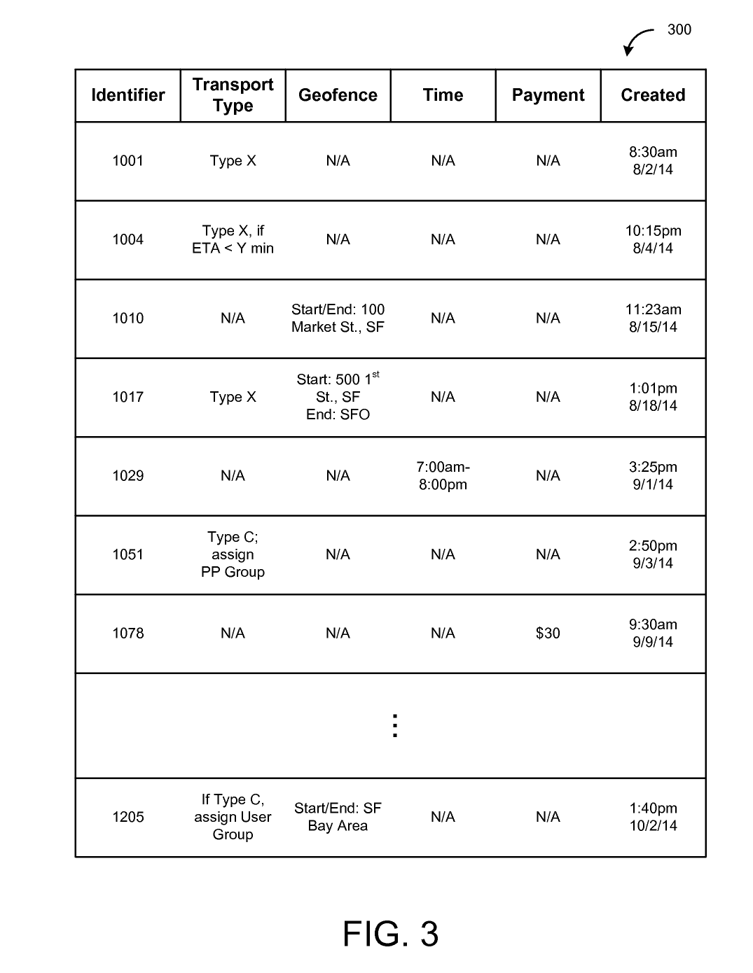

FIG. 3 illustrates an example rules database for use with the on-demand service arrangement system. In one example, a rules database 300 of FIG. 3 can correspond to the rules database 150b of FIG. 1. The rules database 300 can be stored in a memory resource of the system 100 and can include a plurality of entries that each corresponds to a rule and that includes rule data. Depending on implementation, the rules database 300 can be a database that is accessible by business administrators or by users of the system 100 via a portal, or can be a database that is specific to a particular business account or user account (e.g., so that each account can have its own associated database). An administrator or a user can create, edit, and/or associate a rule with the business account or the user account, respectively. For example, the business administrator can create a rule, such as the rule with the identifier 1004, and associate the rule with the corresponding business account, so that transport requests made by authorized employees of that business can be subject to that rule.

As illustrated in FIG. 3, each entry for a rule can have associated rule data, such as a rule identifier, condition information, payment information, and/or a creation time and date. The condition information can include a transport type information, geofence information (e.g., geographic location information), and/or timing information, that can each be configured by an administrator or a user of the system 100. In the example shown in FIG. 3, the rules database 300 can have a plurality of rules that can be individually associated with a business account, such as a Rule 1001, Rule 1004, Rule 1010, Rule 1017, Rule 1029, Rule 1051, Rule 1078, Rule 1205, etc. The example rules are described below.

Rule 1001 specifies that a business will pay for the transport service provided that the transport type specified in the transport request corresponds to Type X. Rule 1004 specifies that a business will pay for the transport service provided that the transport type specified in the transport request corresponds to Type X and if the ETA for Type X is less than a predetermined amount of time, Y min. In such an example, if the ETA for Type X is greater than or equal to Y min, an authorized user can specify a different transport type other than Type X. Rule 1010 specifies that a business will pay for the transport service provided that the transport request specifies a pickup location or a destination location at a predetermined location (or within a predefined distance of the predetermined location, e.g., 1000 feet), such as 100 Market St., San Francisco, Calif. Rule 1017 specifies that a business will pay for the transport service provided that the transport type specified in the transport request corresponds to Type X, and the transport request specifies a pickup location at 500 1st St., San Francisco, Calif. and a destination location at San Francisco International Airport.

Rule 1029 specifies that a business will pay for the transport service provided that the transport request is made during the times between 7:00 am and 8:00 pm. Rule 1051 specifies that a business will pay for the transport service provided that the transport type specified in the transport request corresponds to Type C (e.g., carpool transport type) and instructs the system 100 to first attempt to assign another authorized user of the group of users of authorized the business to carpool with the requesting user (e.g., assign another authorized user who specified the same payment profile ID). Rule 1078 specifies that a business will pay for a maximum of $30 for a transport service. Rule 1205 corresponds to a rule that can be user-specific (and not associated with a business, for example), and specifies that if the transport type specified in the transport request corresponds to Type C, the system 100 is to first attempt to assign another user of a group of friends or acquaintances of the user of authorized the business to carpool with the requesting user. Depending on implementation, multiple rules can also be associated with a business account. For example, a business can associate both Rule 1001 and Rule 1078 so that the business will pay up to $30 for the transport service provided that the transport type specified in the transport request corresponds to Type X.

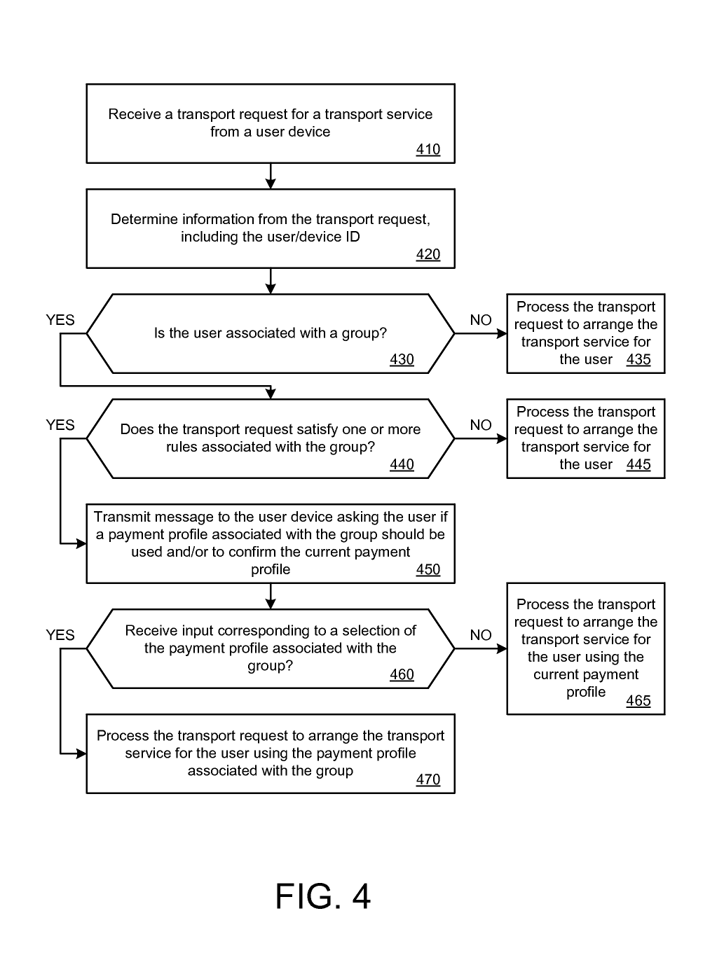

FIG. 4 illustrates another example method for arranging on-demand services based on one or more predefined rules. A method such as described by an example of FIG. 4 can be implemented using, for example, components described with an embodiment of FIG. 1. Accordingly, references made to elements of FIG. 1 are for purposes of illustrating a suitable element or component for performing a step or sub-step being described.

The system 100 can receive a transport request for a transport service from a user's client device (410). As discussed with respect to FIGS. 1 and 2A, for example, the transport request can include an ID associated with the user and/or the client device, a transport type information, a pickup location data point, a destination location data point, and/or a payment profile ID. According to an example, the user may use the service application to request transport services for personal use as well as for business/group use. When a transport request is made, the service application may automatically include a default payment profile ID or the last specified/used payment profile ID in the transport request. Accordingly, the user may have to manually select or change the payment profile ID before making a request for the transport service to ensure that the appropriate financial account is charged when the transport service is completed (e.g., as the default or last used payment profile ID may correspond to a different account than one that the user wants to currently charge). In the example of FIG. 4, the transport request includes a payment profile ID that corresponds to an account of the user (as opposed to a business or group).

In response to receiving the transport request, the system 100 can determine information from the transport request, including the ID associated with the user and/or the client device (e.g., a user ID) (420). The system 100 can determine if the user is associated with a business (or group) using the user ID (430). For example, the system 100 can search the stored business accounts using the user ID to determine if the user ID corresponds to an authorized user ID associated with a business account. If the user ID is not associated with a business (or is associated with a business but not yet authorized by the business), the system 100 can process the transport request normally in order to arrange the transport service for the user (435).

On the other hand, if the system 100 determines that the user is associated with a business (and/or is an authorized user of the business), the system 100 can determine if the transport request satisfies one or more rules associated or specified by the business (440). In some examples, such as described with respect to FIGS. 1 through 3, a business can associate one or more rules with the business's account in order to control the transport services that the business is willing to pay for. If the business does not have any rules associated with the business's account or if the transport request does not satisfy one or more rules associated with the business account, the system 100 can process the transport request normally (and the financial account associated with the payment profile ID of the user can be charged at a later time when the transport service is completed) (445). For example, the transport request may include a certain pickup location and/or destination location, or specify a particular transport type that does not match the condition(s) specified by a rule.

However, if the transport request satisfies one or more rules associated with the business account, the system 100 can transmit a message to the user's client device asking the user if a payment profile associated with the business should be used to in order to pay for the transport service and/or asking the user to confirm the current payment profile (450). In other words, because the user's transport request satisfies one or more rules of a business that the user is associated with, the system 100 can provide the user with an opportunity to change or select the appropriate payment profile for the user's transport service. In one example, the system 100 can determine if it has received an input corresponding to a selection of the payment profile ID associated with the business (460). If no such input is received (e.g., after a predetermined amount of time, such as ten seconds) or if the user confirms that the current payment profile ID is to be used for the transport service, the system 100 can process the transport request to arrange the transport service using the current payment profile ID from the transport request (465). On the other hand, if the system 100 receives an input corresponding to the selection of the payment profile ID associated with the business, the system 100 can process the transport request to arrange the transport service using the payment profile ID associated with the business (470). In such case, if the user has forgotten to select or change the payment profile ID to one that corresponds to a business before making the transport request, the user can provide an input to specify that the user wants the transport service to be paid by the payment profile ID associated with the business.

As an addition or an alternative, in one example, if the system 100 determines that the transport request satisfies one or more rules associated with the business (e.g., step 440), the system 100 can process the transport request to arrange the transport service for the user (e.g., select a driver for the user). At a duration of time after the transport service is arranged, such as when the transport service is being provided to the user or after the transport service has been completed, the system 100 can transmit a message to the user's client device asking the user if a payment profile associated with the business should be used to in order to pay for the transport service and/or asking the user to confirm the current payment profile (e.g., step 450). In such an example, the user can have the option to select the appropriate payment profile ID at a time before any payment for the transport service is made.

### Hardware Diagrams

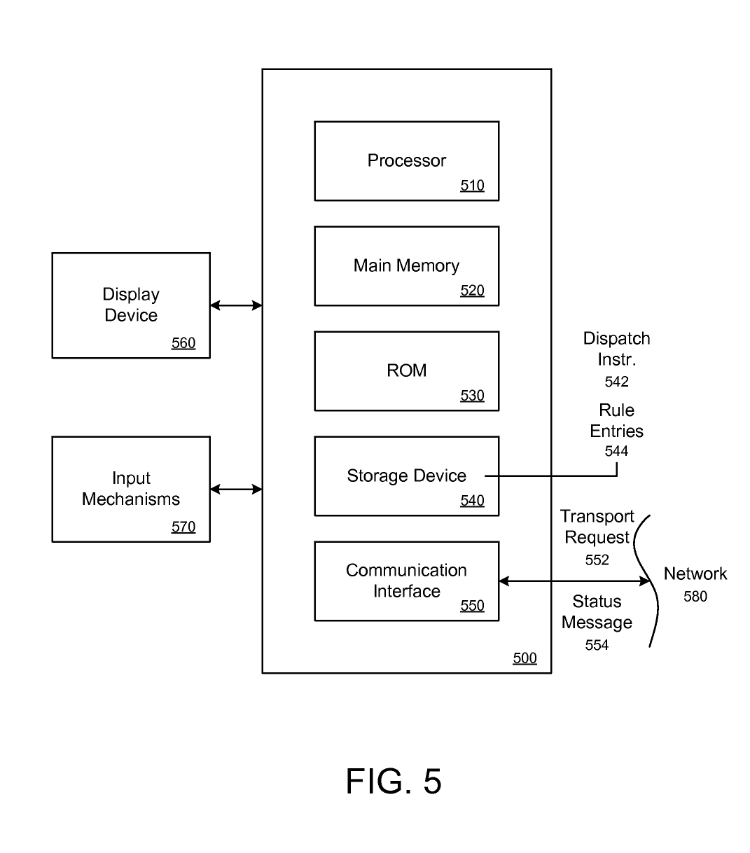

FIG. 5 is a block diagram that illustrates a computer system upon which embodiments described herein may be implemented. For example, in the context of FIG. 1, the system 100 may be implemented using a computer system such as described by FIG. 5. The system 100 may also be implemented using a combination of multiple computer systems as described by FIG. 5.

In one implementation, a computer system 500 includes processing resources 510, a main memory 520, a read only memory (ROM) 530, a storage device 540, and a communication interface 550. The computer system 500 includes at least one processor 510 for processing information and the main memory 520, such as a random access memory (RAM) or other dynamic storage device, for storing information and instructions to be executed by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions, including dispatch instructions 542, a plurality of rule entries 544, and account information (e.g., user accounts and/or business accounts).

For example, the processor 510 can execute the dispatch instructions 542 to implement logic for receiving transport requests from client devices, and accessing databases for purposes of determining if transport requests are valid and should be processed, such as described in FIGS. 1 through 4. The dispatch instructions 542, when executed, can cause the computer system 500 to determine, based on information from a transport request 552, whether the transport request 552 is subject to any rule(s). The processor 510 can also execute the dispatch instructions 544 to implement logic for processing transport requests and selecting drivers for users, such as described in FIGS. 1 through 4.

The communication interface 550 can enable the computer system 500 to communicate with one or more networks 580 (e.g., cellular network) through use of the network link (e.g., wirelessly or via a wire). Using the network link, the computer system 500 can communicate with client devices, driver devices, and/or one or more other servers or datacenters. According to some examples, the computer system 500 can receive a transport request 552 from a client device of a user via the network link, determine information from the transport request 552, such as a payment profile ID, determine whether the transport request 552 is subject to any rules, and determine whether the transport request 552 is valid. If the transport request 552 is valid, the computer system 500 can process the transport request 552 to select a driver for the user, and transmit a status message 554 indicating to the user that the driver has been assigned for the user. On the other hand, if the transport request 552 is invalid, the computer system 500 can transmit a status message 554 requesting the user to change the payment profile ID or providing the user with information instructing the user to conform to the one or more rules in order to make a valid transport request, such as described in FIGS. 1 through 4.

The computer system 500 can also include a display device 560, such as a cathode ray tube (CRT), an LCD monitor, or a television set, for example, for displaying graphics and information to a user. One or more input mechanisms 570, such as a keyboard that includes alphanumeric keys and other keys, can be coupled to the computer system 500 for communicating information and command selections to the processor 510. Other non-limiting, illustrative examples of input mechanisms 570 include a mouse, a trackball, touch-sensitive screen, or cursor direction keys for communicating direction information and command selections to the processor 510 and for controlling cursor movement on the display 560.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

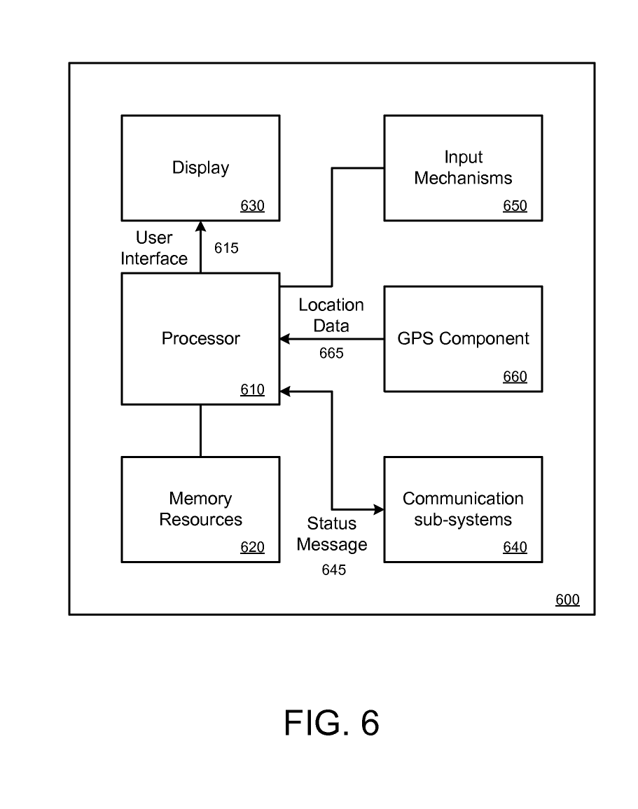

FIG. 6 is a block diagram that illustrates a mobile computing device upon which embodiments described herein may be implemented. In one embodiment, a computing device 600 may correspond to a mobile computing device, such as a cellular device that is capable of telephony, messaging, and data services. The computing device 600 can correspond to a client device or a driver device. Examples of such devices include smartphones, handsets or tablet devices for cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

The processor 610 can provide a variety of content to the display 630 by executing instructions and/or applications that are stored in the memory resources 620. For example, the processor 610 is configured with software and/or other logic to perform one or more processes, steps, and other functions described with implementations, such as described by FIGS. 1 through 5, and elsewhere in the application. In particular, the processor 610 can execute instructions and data stored in the memory resources 620 in order to operate a client application, as described in FIGS. 1 through 5. Still further, the processor 610 can cause one or more user interfaces 615 to be displayed on the display 630, such as one or more user interfaces provided by the client application.

A user can operate the computing device 600 to operate the client application in order to make a request for a transport service. For example, the computing device 600 can determine a location data point 665 of the current location of the computing device 600 from the GPS component 660 and provide the location data point 665 to the transport arrangement system (not shown in FIG. 6). The transport arrangement system can receive the transport request and determine whether the transport request is valid based on the determination that the transport request is subject to one or more rules (e.g., that is specified by a group that the user is associated with). If the transport arrangement system determines that the transport request is valid because the information associated with the transport request satisfies one or more conditions of the one or more rules, the transport arrangement system can process the transport request normally in order to select a driver for the user and can transmit a status message 645 to the computing device 600 indicating as such. The client application can display, as part of a user interface 615, text corresponding to the status message 645. While FIG. 6 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method of arranging a transport service, the method being performed by a computing system and comprising:
receiving, from a user device, a transport request for a transport service for a user operating the user device, the transport request including (i) an identifier (ID) associated with the user or the user device, (ii) a transport type information, (iii) a pickup location, and (iv) a payment profile ID;
based, at least in part, on the payment profile ID, determining, at the computing system, that the transport request is subject to one or more rules stored in a rules database accessible by the computing system;
in response to determining that the transport request is subject to one or more rules, determining, at the computing system, whether the transport request is valid based, at least in part, on (i) the one or more rules, and (ii) at least one of the transport type information or the pickup location; and
in response to determining that the transport request is valid, processing the transport request, wherein processing the transport request includes selecting a driver to provide the transport service for the user.

2. The method of claim 1, wherein determining that the transport request is subject to one or more rules includes (i) determining that the user is associated with a group of users, wherein information about the group is stored in a group database accessible by the computing system, and (ii) determining that the one or more rules are specified for the group.

3. The method of claim 2, wherein determining that the transport request is subject to one or more rules includes identifying the group from the group database using the payment profile ID, and wherein the group is associated with one or more payment profiles, including a payment profile corresponding to the payment profile ID.

4. The method of claim 2, wherein the transport request also includes a destination location, and wherein the transport type information included in the transport request corresponds to a carpool transport type;
wherein a rule of the one or more rules specifies that when transport requests are made for the carpool transport type, the computing system is to first attempt to select a second user to share at least a portion of the transport service with the user from the group of users before attempting to select from other users not in the group; and
wherein processing the transport request includes selecting the second user from the group of users based on the pickup location and the destination location, and a second pickup location and a second destination location of the second user.

5. The method of claim 1, wherein a rule of the one or more rules specifies that transport requests are only to be made for a particular transport type; and
wherein determining whether the transport request is valid includes determining whether the transport type information included in the transport request corresponds to the particular transport type specified by the rule.

6. The method of claim 1, wherein a rule of the one or more rules specifies that transport requests are only to be made for a particular transport type when an estimated time of arrival (ETA) of the particular transport type for the transport service is equal to or less than a predetermined amount of time; and
wherein determining whether the transport request is valid includes (i) determining the ETA of the particular transport type that is based on the pickup location included in the transport request, and (ii) determining whether the transport type information included in the transport request corresponds to the particular transport type specified by the rule, or determining whether the ETA of the particular transport type is greater than the predetermined amount of time specified by the rule.

7. The method of claim 1, wherein a rule of the one or more rules specifies that transport requests are to have a particular pickup location region; and
wherein determining whether the transport request is valid includes determining whether the pickup location included in the transport request is within the particular pickup location region specified by the rule.

8. The method of claim 1, wherein a rule of the one or more rules specifies that transport requests are to be made during a predetermined duration of time; and
wherein determining whether the transport request is valid includes determining whether the transport request has been received by the computing system at a time during the predetermined duration of time.

9. The method of claim 1, wherein a rule of the one or more rules specifies that transport requests are only to be made a maximum number of times by the user during a predetermined duration of time; and
wherein determining whether the transport request is valid includes (i) accessing a user database to determine an account of the user based on the identifier, and (ii) determining, from the account, a number of previous transport services that were completed for the user during the predetermined duration of time specified by the rule.

10. The method of claim 1, further comprising:
determining, at the computing system, that the transport service has been completed for the user based on information received from a driver device of the selected driver;
determining, at the computing device, a cost for the transport service based on location information and time information of the transport service; and
based on the one or more rules, determining, at the computing device, what portion of the cost to charge to a financial account associated with the payment profile ID.

11. The method of claim 10, wherein a rule of the one or more rules specifies that costs for transport services can be paid using the account associated with the payment profile ID when transport services are completed at a particular destination location region.

12. A non-transitory computer-readable medium storing instructions that, when executed by a processor of a computing system, causes the computing system to:
receiving, from a user device, a transport request for a transport service for a user operating the user device, the transport request including (i) an identifier (ID) associated with the user or the user device, (ii) a transport type information, (iii) a pickup location, and (iv) a payment profile ID;
based, at least in part, on the payment profile ID, determining, at the computing system, that the transport request is subject to one or more rules stored in a rules database accessible by the computing system;
in response to determining that the transport request is subject to one or more rules, determining, at the computing system, whether the transport request is valid based, at least in part, on (i) the one or more rules, and (ii) at least one of the transport type information or the pickup location;
if the transport request is determined to be invalid, transmitting, to the user device, a message indicating that the transport request is invalid; and
if the transport request is determined to be valid, processing the transport request, wherein processing the transport request includes selecting a driver to provide the transport service for the user.

13. The non-transitory computer-readable medium of claim 12, wherein the instructions further cause the computing system to:
if the transport request is determined to be invalid, (i) determine at least one of textual data corresponding to a proper transport type or textual data corresponding to a proper pickup location as required by the one or more rules for the transport request to be valid, and (ii) include, in the message, the textual data corresponding to the proper transport type or the textual data corresponding to the proper pickup location.

14. The non-transitory computer-readable medium of claim 12, wherein the instructions cause the computing system to determine that the transport request is subject to one or more rules by (i) determining that the user is associated with a group of users by identifying the group from the group database using the payment profile ID, wherein the group is associated with one or more payment profiles, including a payment profile corresponding to the payment profile ID, and wherein information about the group is stored in a group database accessible by the computing system, and (ii) determining that the one or more rules are specified for the group.

15. The non-transitory computer-readable medium of claim 14, wherein the transport request also includes a destination location, and wherein the transport type information included in the transport request corresponds to a carpool transport type;
wherein a rule of the one or more rules specifies that when transport requests are made for the carpool transport type, the computing system is to first attempt to select a second user to share at least a portion of the transport service with the user from the group of users before attempting to select from other users not in the group; and
wherein processing the transport request includes selecting the second user from the group of users based on the pickup location and the destination location, and a second pickup location and a second destination location of the second user.

16. The non-transitory computer-readable medium of claim 12, wherein a rule of the one or more rules specifies that transport requests are only to be made for a particular transport type; and
wherein the instructions cause the computing system to determine whether the transport request is valid by determining whether the transport type information included in the transport request corresponds to the particular transport type specified by the rule.

17. The non-transitory computer-readable medium of claim 12, wherein a rule of the one or more rules specifies that transport requests are only to be made for a particular transport type when an estimated time of arrival (ETA) of the particular transport type for the transport service is equal to or less than a predetermined amount of time; and
wherein the instructions cause the computing system to determine whether the transport request is valid by (i) determining the ETA of the particular transport type that is based on the pickup location included in the transport request, and (ii) determining whether the transport type information included in the transport request corresponds to the particular transport type specified by the rule, or determining whether the ETA of the particular transport type is greater than the predetermined amount of time specified by the rule.

18. The non-transitory computer-readable medium of claim 12, wherein a rule of the one or more rules specifies that transport requests are to have a particular pickup location region; and
wherein the instructions cause the computing system to determine whether the transport request is valid by determining whether the pickup location included in the transport request is within the particular pickup location region specified by the rule.

19. The non-transitory computer-readable medium of claim 12, wherein a rule of the one or more rules specifies that transport requests are to be made during a predetermined duration of time; and
wherein the instructions cause the computing system to determine whether the transport request is valid by determining whether the transport request has been received by the computing system at a time during the predetermined duration of time specified by the rule.

20. The non-transitory computer-readable medium of claim 12, wherein the instructions cause the computing system to further:
determine, at the computing system, that the transport service has been completed for the user based on information received from a driver device of the selected driver;
determine, at the computing device, a cost for the transport service based on location information and time information of the transport service; and
based on the one or more rules, determine, at the computing device, what portion of the cost to charge to a financial account associated with the payment profile ID.
